(19) United States
(12) Patent Application Publication
(10) Pub. No.: US 2017/0144177 A1
(43) Pub. Date: May 25, 2017

(54) DEVICE FOR DISPENSING A FLUID PRODUCT

(71) Applicant: APTAR FRANCE SAS, Le Neubourg (FR)

(72) Inventors: Frederic HELDT, Louviers (FR); Baptiste LEBEL, Evreux (FR)

(73) Assignee: APTAR FRANCE SAS, Le Neubourg (FR)

(21) Appl. No.: 15/323,273

(22) PCT Filed: Jul. 2, 2015
(86) PCT No.: PCT/FR2015/051843

§ 371 Date: Dec. 30, 2016

(30) Foreign Application Priority Data
Jul. 4, 2014 (FR) 1456501

(51) Int. Cl. B05B 11/02; B05B 11/00

(52) U.S. Cl. CPC B05B 11/02; B05B 11/0008

(57) ABSTRACT

A fluid dispenser device with a body (1) and an axially movable dispenser head (2). The body receives a reservoir (10) that has a hollow tube (11) having a proximal axial opening (12) closed by a stopper (20) that slides in leaktight manner in the tube during actuation. The dispenser head includes a cylindrical cannula (4) connected to the dispenser orifice (3) and a perforating tip (5) with an opening (6) for perforating the stopper. The stopper has a radial wall (22) perforated by the cannula during actuation, the opening of the cannula defining a peripheral edge (7) around the opening and that includes an axial end and a proximal end separate by an axial extent of the opening (6). Two doses of fluid are dispensed during two successive actuations, the axial extent of the opening being less than the axial thickness of the radial wall of said stopper.

### BACKGROUND OF THE INVENTION

The present invention relates to a fluid dispenser device. More particularly, it relates to a device of the two-dose type that is adapted to dispense two doses of fluid in two successive actuations.

Devices of the single-dose or two-dose type are well known. As can be seen in FIG. 1, they generally comprise a body 1 that receives a reservoir 10 containing one or two doses of fluid, and a dispenser head 2 that is provided with a dispenser orifice 3, and that is axially movable relative to said body 1 during actuation. The reservoir 10 is generally formed by a blind hollow tube 11 having an axial opening 12 that is proximal (relative to the dispenser orifice 3) and that is closed in leaktight manner by a stopper 20. The dispenser head 2 generally includes a cannula or needle 4 of generally cylindrical shape that is connected at one end to said dispenser orifice 3, and that is provided at its other end with a perforating tip 5 that is adapted to perforate said stopper 20 during actuation, the stopper 20 then moving in said reservoir 10 so as to expel the dose(s) of fluid through said cannula 4, towards said dispenser orifice 3. Document EP 0 546 607 describes a device of this type.

A drawback with prior-art devices relates to the risk of leaks during actuation, which changes the dose dispensed and degrades metering reproducibility between various devices of the same type. In particular, as can be seen in FIG. 2, the opening 6 in the perforating tip 5 of the cannula 4 is generally formed by a bevel at its axial end that is distal (relative to the dispenser orifice 3), thus forming a peripheral edge 7 of plane surface that surrounds said opening 6. In order to make it easier to perforate the stopper 20, the angle of said bevel is relatively sharp, such that the axial extent of said opening 6, i.e. the axial distance between the distal axial end and the proximal axial end of said peripheral edge 7, can be greater than the thickness of the wall 22 of the stopper 20 that is perforated by said cannula 4 at the beginning of actuation. This can thus lead to leaks while the stopper 20 is being perforated, with fluid potentially flowing out from the reservoir 10 without passing into said cannula 4. The risk of leaks is particularly present in devices of the two-dose type that contain a greater amount of fluid to be dispensed.

An object of the present invention is to provide a fluid dispenser device, in particular of the single-dose or two-dose type, that does not have the above-mentioned drawbacks.

Another object of the present invention is to provide a fluid dispenser device, in particular of the two-dose type, that improves metering accuracy and metering reproducibility for a plurality of devices of the same type, by limiting or eliminating the risk of leaks during actuation.

Another object of the present invention is to provide a fluid dispenser device, in particular of the two-dose type, that is simple and inexpensive to manufacture and to assemble.

### SUMMARY OF CERTAIN EMBODIMENTS OF THE INVENTION

The present invention thus provides a fluid dispenser device comprising a body, and a dispenser head that is provided with a dispenser orifice and that is axially movable relative to said body during actuation, said body receiving a reservoir containing fluid, said reservoir comprising a hollow tube having a proximal axial opening that is closed by a stopper that is adapted to slide in leaktight manner in said tube during actuation, said dispenser head including a hollow cylindrical cannula that is connected at one end to said dispenser orifice, and that is provided at its other end with a perforating tip provided with an opening for perforating said stopper, said stopper having a radial wall that is perforated by said cannula during actuation, said opening of said cannula defining a peripheral edge that extends around said opening and that includes a distal axial end and a proximal axial end, the axial distance between said distal axial end and said proximal axial end of said peripheral edge defining an axial extent of said opening, said reservoir containing two doses of fluid for dispensing during two successive actuations of the device, said axial extent of said opening of said perforating tip being less than the axial thickness of said radial wall of said stopper.

Advantageously, said opening is formed by a bevel that is formed in the distal axial end of said cannula.

Advantageously, said cannula has an outside diameter of 0.99 millimeters (mm), the angle formed by said bevel, which defines said opening, with the cylindrical wall of said cannula lying in the range 10° to 80°, advantageously 34°.

Advantageously, said radial wall of the stopper (has an axial thickness of 1.6 mm, and the axial extent of said opening is less than 1.6 mm, in particular about 1.05 mm.

Advantageously, said reservoir is formed by a blind hollow tube.

### BRIEF DESCRIPTION OF THE DRAWINGS

These characteristics and advantages and others appear more clearly from the following detailed description, given by way of non-limiting examples, and with reference to the accompanying drawings, and in which:

FIG. 1 is a diagrammatic view of a dispenser device of the two-dose type to which the present invention may be applied;

FIG. 2 is a section view of a detail of a standard device of the prior art;

FIG. 3 is a view similar to the view in FIG. 2, showing an advantageous embodiment of the present invention;

FIG. 4 is a perspective view of a detail of the opening of the perforating tip of the cannula; and

FIG. 5 is a section view of a detail of said perforating tip.

### DESCRIPTION OF THE PREFERRED EMBODIMENTS

The present invention relates more particularly to a device of the type disclosed in document EP 0 546 607.

However, it should be understood that the present invention is not limited to that type of device, but, on the contrary, applies to any type of fluid dispenser device of the two-dose type or of the multi-dose type that includes a reservoir closed by a stopper, said stopper needing to be perforated prior to actuation or at the beginning of actuation.

In the description, the terms “axial” and “radial” are relative in particular to the longitudinal direction of the cylindrical cannula 4. The terms “proximal” and “distal” are relative to the dispenser orifice 3 formed in the dispenser head 2.

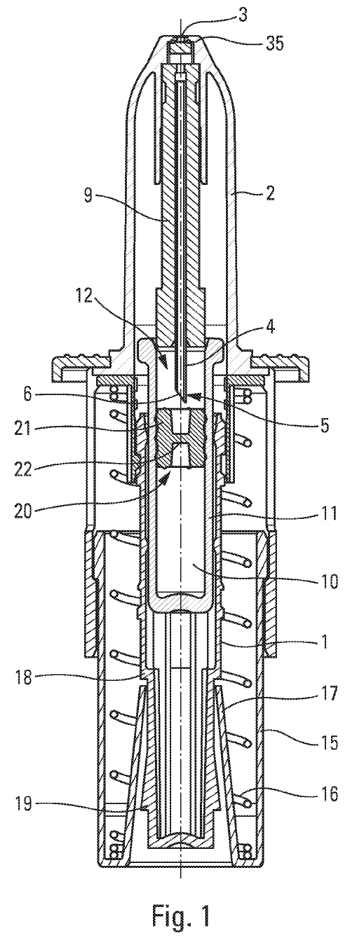

The invention applies more particularly to devices of the two-dose type as shown in FIG. 1. As described above, such a device includes a body 1 that receives a reservoir 10 containing two doses of fluid, and a dispenser head 2, provided with a dispenser orifice 3, is axially movable relative to said body 1 during actuation.

The reservoir 10 contains two doses of fluid. Advantageously, said reservoir 10 is formed by a blind hollow tube 11, e.g. made of glass, having an axial opening 12 that is closed by a stopper 20, e.g. made of elastomer, that is adapted to slide in leaktight manner in said tube 11 during actuation. Said stopper 20 comprises both a tubular axial portion 21 that slides in leaktight manner in the tube 11, and also a radial or transverse wall 22 for being perforated by a cannula 4 during actuation.

The dispenser head 2 generally includes a cannula or needle 4 of generally cylindrical shape that is connected at one end to said dispenser orifice 3, and that is provided at its other end with a perforating tip 5 that is adapted to perforate said stopper 20 during actuation, the stopper 20 thus being moved in said reservoir 10 so as to expel the doses of fluid through said cannula 4, towards said dispenser orifice 3. The cannula 4 may be inserted into a cannula support 9 that may itself be fastened in said dispenser head 2. Advantageously, a spray profile 35 may be formed directly upstream from the dispenser orifice 3, e.g. between the end wall of said dispenser head 2 and the proximal axial end of said cannula support 9.

An actuator member 15 connected to said body 1 may be provided to perform actuation. In the embodiment shown in FIG. 1, the actuator member 15 is urged towards its rest position by a spring 16, and is movable manually against the force of the spring 16 so as to move both the body 1 and the reservoir 10 relative to the dispenser head 2. Since the embodiment in FIG. 1 is a two-dose dispenser device, the actuator member includes dose-splitting means that, in this embodiment, are in the form of one or more flexible tabs 17 that co-operate with respective radial shoulders 18, 19 formed on said body 1. Thus, in order to dispense the first dose, the flexible tab 17 co-operates with the shoulder 18, then the spring 16 returns the actuator member 15 into its rest position in which said flexible tab co-operates with the second shoulder 19. Other dose-splitting means may be envisaged.

As explained above, the opening 6 of said cannula 4 defines a peripheral edge 7 that extends around said opening 6, as can be seen in particular in FIG. 4. The peripheral edge 7 includes a distal axial end and a proximal axial end, the axial distance between said distal axial end and said proximal axial end of said peripheral edge 7 defining an axial extent d of said opening 6, as can be seen in FIG. 5.

In the invention, said axial extent d of said opening 6 of said perforating tip 5 is less than the axial thickness of said radial wall 22 of said stopper 20.

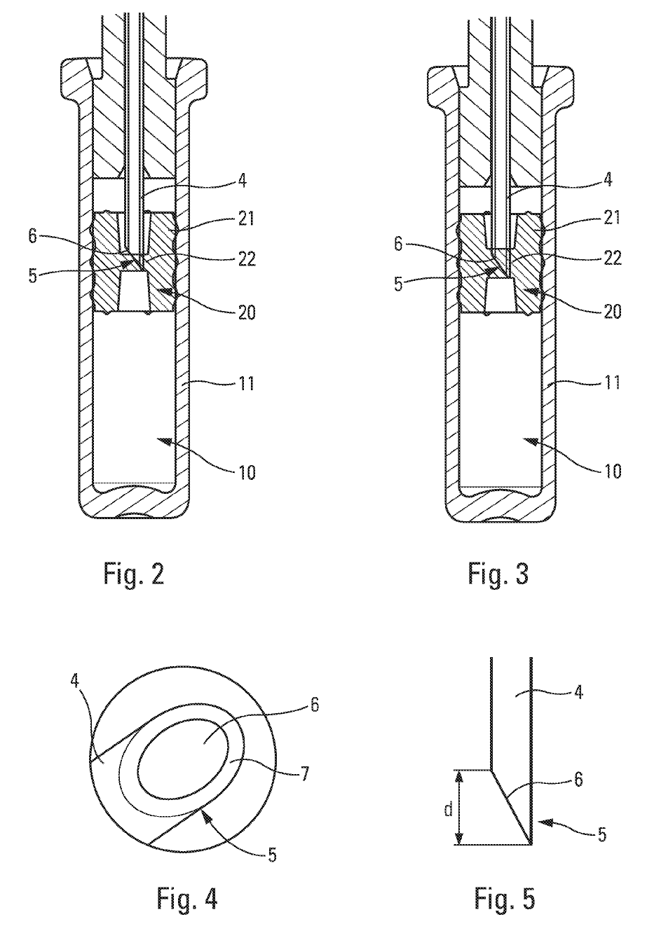

To do this, the thickness of the radial wall 22 is increased compared to a standard stopper as shown in FIG. 2. In this configuration, the cannula 4 does not need to be modified.

By way of example, said cannula 4 may have an outside diameter of 0.99 mm, the angle formed by the bevel, which defines said opening 6, with the cylindrical wall of said cannula 4 thus lying in the range 10° to 80°, advantageously 34°.

Advantageously, said radial wall 22 of the stopper 20 has an axial thickness of 1.6 mm, and the axial extent d of said opening 6 is less than 1.6 mm, in particular about 1.05 mm. By way of comparison, a standard stopper as shown in FIG. 2 has a radial wall having a thickness of 1 mm. By keeping the same cannula, the radial thickness of the radial wall 22 is thus increased by about 60% in the present invention. This increase remains acceptable in terms of the force required to perforate said radial wall 22 during actuation.

With the present invention, no leak can occur at said opening 6 while the radial wall 22 of the stopper 20 is being perforated.

The present invention is described above with reference to an advantageous embodiment, but naturally any modification could be applied thereto by a person skilled in the art, without going beyond the ambit of the present invention, as defined by the accompanying claims.

1. A fluid dispenser device comprising a body (1), and a dispenser head (2) that is provided with a dispenser orifice (3) and that is axially movable relative to said body (1) during actuation, said body (1) receiving a reservoir (10) containing fluid, said reservoir (10) comprising a hollow tube (11) having a proximal axial opening (12) that is closed by a stopper (20) that is adapted to slide in leaktight manner in said tube (11) during actuation, said dispenser head (2) including a hollow cylindrical cannula (4) that is connected at one end to said dispenser orifice (3), and that is provided at its other end with a perforating tip (5) provided with an opening (6) for perforating said stopper (20), said stopper (20) having a radial wall (22) that is perforated by said cannula (4) during actuation, said opening (6) of said cannula (4) defining a peripheral edge (7) that extends around said opening (6) and that includes a distal axial end and a proximal axial end, the axial distance between said distal axial end and said proximal axial end of said peripheral edge (7) defining an axial extent (d) of said opening (6), said reservoir (10) containing two doses of fluid for dispensing during two successive actuations of the device, and in that said axial extent (d) of said opening (6) of said perforating tip (5) is less than the axial thickness of said radial wall (22) of said stopper (20), the device being characterized in that said radial wall (22) of the stopper (20) has an axial thickness of 1.6 mm, and the axial extent (d) of said opening (6) is less than 1.6 mm, in particular about 1.05 mm.

2. A device according to claim 1, wherein said opening (6) is formed by a bevel that is formed in the distal axial end of said cannula (4).

3. A device according to claim 2, wherein said cannula (4) has an outside diameter of 0.99 mm, the angle formed by said bevel, which defines said opening (6), with the cylindrical wall of said cannula (4) lying in the range 10° to 80°, advantageously 34°.

4. A device according to claim 1, wherein said reservoir (10) is formed by a blind hollow tube (11).

5. (canceled)
